(19) United States
(12) Patent Application Publication
(10) Pub. No.: US 2013/0135972 A1
(43) Pub. Date: May 30, 2013

(54) ELECTRONIC TIMEPIECE

(71) Applicant: Seiko Instruments Inc., Chiba (JP)

(72) Inventors: Hisao NAKAMURA, Chiba (JP); Hideki OKUDA, Chiba (JP)

(73) Assignee: Seiko Instruments Inc., Chiba (JP)

(21) Appl. No.: 13/676,384

(22) Filed: Nov. 14, 2012

(30) Foreign Application Priority Data
Nov. 24, 2011 (JP) 2011-256277

(51) Int. Cl. G04G 21/02; G04G 17/02

(52) U.S. Cl. CPC G04G 21/02; G04G 17/02
USPC 368/11

(57) ABSTRACT

An electronic timepiece includes an external case, a pressure sensor provided in the external case for detecting pressure, and a protection case surrounding an outer peripheral surface of the pressure sensor to protect and support the pressure sensor. A sensor housing opening is formed in the external case and houses the pressure sensor and the protection case, and the protection case is arranged near a center portion of the sensor housing opening. A case holding gasket has a cylindrical portion fitted between an inside surface of the sensor housing opening and an outside surface of the protection case through a given interference with respect to the sensor housing opening and the protection case. An inward flange portion is provided in the case holding gasket and regulates movement in a direction in which the protection case falls off the external case toward the outside.

### BACKGROUND OF THE INVENTION

1. Field of the Invention

The present invention relates to an electronic timepiece including a pressure sensor which can measure, for example, atmospheric pressure or water pressure.

2. Background Art

As this type of electronic timepieces, there exists sensor watches provided with, for example, a sensor unit such as a pressure sensor. Among these sensor watches, there is one in which an opening is formed in a device case (external case) and the sensor unit is housed in the opening from the outside of the device case. In this case, the sensor unit is configured to foe pressed onto the opening by a holding panel through a gasket, thereby securing sealing property inside the device case. Additionally, a cover plate is covered from the holding panel and the cover plate is fixed to the device case by using screws to thereby keep a pressed state of the holding panel (refer to, for example, JP-A-4-282489 (Patent Document 1).

However, in the above related art, it is necessary to fix the cover plate by using screws to keep the pressed state of the holding panel by using the cover plate. Therefore, it is necessary to secure spaces for inserting screws into the cover plate as well as to secure spaces for driving screws in the device case. Accordingly, there is a problem that the sensor watch becomes large in size.

### SUMMARY OF THE INVENTION

It is an aspect of the present application to provide an electronic timepiece having a pressure sensor, which can be made small in size.

An electronic timepiece according to the present application includes an external case, a pressure sensor provided in the external case and detecting pressure, and a protection case formed so as to surround an outer peripheral surface of the pressure sensor, which can protect and support the pressure sensor, in which a sensor housing opening which can house the pressure sensor and the protection case is termed in the external case, and the protection case is arranged near a center portion of the sensor housing opening, a case holding gasket having a cylindrical portion fitted between an inside surface of the sensor housing opening and an outside surface of the protection case through a given interference with respect to the sensor housing opening and the protection case, and a fall-off regulating portion for the protection case regulating movement in a direction in which the protection case falls oft the external case toward the outside is provided in the case holding gasket.

When applying the above structure, lateral pressure generated by the cylindrical portion of the case holding gasket is applied to the inside surface of the sensor housing opening formed in the external case and the outside surface of the protection case. Due to the lateral pressure, sliding resistance between the case holding gasket end the protection case is increased, thereby preventing the protection case from falling off the external case.

As the fall-off regulating portion for the protection case is provided in the case holding gasket, it is possible to possibly prevent the protection case from falling off the external case even when inner pressure becomes higher than external pressure of the external case. Accordingly, the falling of the protection case supporting the pressure sensor from the external case can be prevented without pressing the protection case from the outside by using a cover plate and so on as in related art. Accordingly, it is not necessary to use the cover plate, screws for fixing the cover plate as well as to secure spaces for inserting and driving screws, therefore, the number of components can be reduced and the entire electronic device can be made small in size.

In the electronic timepiece according to the present application, the fall-off regulating portion for the protection case is an inward flange portion formed in the cylindrical portion.

When applying the above structure, it is possible to prevent the protection case from falling off the external case with a simple structure inexpensively.

In the electronic timepiece according to the present application, a fall-off regulation portion for the gasket regulating movement in a direction in which the case holding basket falls off the external case toward the outside is provided inside the external case in a thickness direction on an inside surface of the sensor housing opening.

When applying the above structure, it is possible to positively prevent the case holding gasket from falling off the external case. Therefore, the falling of the protection case can be positively prevented by the case holding gasket, which improves product reliability.

In the electronic timepiece according the present application, a rough surface portion which is rougher in surface roughness than other portions is formed on the inside surface of the sensor housing opening and the rough surface portion is formed as the fall-off regulation portion for the gasket.

When applying the above structure, it is possible to prevent the case holding gasket from falling off the external case with a simple structure inexpensively.

In the electronic timepiece according to the present application, a groove portion is formed on an outside end surface in the axial direction of the cylindrical portion as well as an insertion device formed so as so be inserted to the groove portion and extending the groove portion in a thickness direction of the cylindrical portion.

When applying the above structures, the lateral pressure applied to the inside surface of the sensor housing opening formed in the external case and the outside surface of the protection case can be increased by the case holding gasket. Therefore, the sliding resistance between the case holding gasket and the protection case is further increased and the falling of the protection case from the external case can be prevented more positively.

Also, since the thickness of the cylindrical portion of the case holding gasket can be reduced by the thickness corresponding to the formed groove, it is possible to prevent occurrence of sink marks at the time of molding when the case holding gasket is formed by metallic molding. As a result, size variation of the case holding gasket can be reduced as well as sealing property due to the case holding gasket can be improved.

In the electronic timepiece according to present application, a hook portion which can be engaged with the sensor housing opening is provided in the cylindrical portion.

When applying the above structure, it is possible to positively prevent the case holding gasket from falling off the external case. Therefore, the falling of the protection case can be positively prevented by the case holding gasket, which improves product reliability.

In the electronic timepiece according to the present application, a conductive sheet is arranged at an outside end in the axial direction of the protection case and a back-cover touch portion provided in the external case so as to touch the back cover is provided in the sheet.

When applying the above structure, the pressure sensor can be covered with the conductive sheet from the front thereof with a simple structure. Additionally, when the sheet touches the back cover to ground the sheet, it is possible to prevent malfunction of tire pressure sensor due to electrostatic.

According to the present application, the lateral pressure generated by the cylindrical portion of the case holding gasket is applied to the inside surface of the sensor housing opening formed in the external case and the outside surface of the protection case. Due to the lateral pressure, sliding resistance between the case holding gasket and the protection case is increased, thereby preventing the protection case from falling off the external case.

Additionally, as the fall-off regulating portion for the protection case is provided in the case holding gasket, it is possible to prevent the protection case from falling off the external case, for example, even when inner pressure becomes higher than external pressure of the external case. Accordingly, the falling of the protection case supporting the pressure sensor from the external case can be prevented without pressing the protection case from the outside by using a cover plate and so on as in related art. Accordingly, it is not necessary to use the cover plate, screws tor fixing the cover plate as well as to secure spaces for inserting and driving screws, therefore, the number of components can be reduced and the entire electronic device can be made small in size.

### BRIEF DESCRIPTION OF THE DRAWINGS

FIG. 1 a back surface view of an electronic watch with a pressure sensor in a state in which a back cover is removed according to a first embodiment of the present invention;

FIG. 2 is a vertical cross-sectional view of the electronic watch with the pressure sensor according to the first embodiment of the present invention;

FIG. 3 is an enlarged view of a portion “A” in FIG. 2;

FIGS. 4A and 4B show the details of a sensor housing opening according to the first embodiment of the present invention, in which FIG. 4A is a cross-sectional view in the vicinity of the sensor housing opening in an external case and FIG. 4B is a view seen from an arrow “R” in FIG. 4A;

FIG. 5 is a plan view of a sensor cover according to the first embodiment of the present invention;

FIGS. 6A to 6C show a sensor unit according to the first embodiment of the present invention, in which FIG. 6A is a plan view seen from one direction, FIG. 6B is a side view and FIG. 6C is a plan view seen from the other direction;

FIGS. 7A to 7C snow a state in which a case holding gasket is attached to the sensor unit according to the first embodiment of the present invention, in which a FIG. 7A is a plan view seen from one direction, FIG. 7B is a side view and FIG. 7C is a plan view seen from the other direction;

FIG. 8 is a perspective view seen from an arrow “C” in FIG. 2;

FIG. 9 is a vertical cross-sectional view of an electronic watch with a pressure sensor according to a second embodiment of the present invention;

FIG. 10 is a vertical cross-sectional view of an electronic watch with a pressure sensor according to a third embodiment of the present invention;

FIG. 11 is a vertical cross-sectional view of an electronic watch with a pressure sensor according to a fourth embodiment of the present invention; and

FIG. 12 is a perspective view seen from an arrow “D” of FIG. 11.

### DESCRIPTION OF THE PREFERRED EMBODIMENTS

### First Embodiment

### (Electronic Watch With Pressure Sensor)

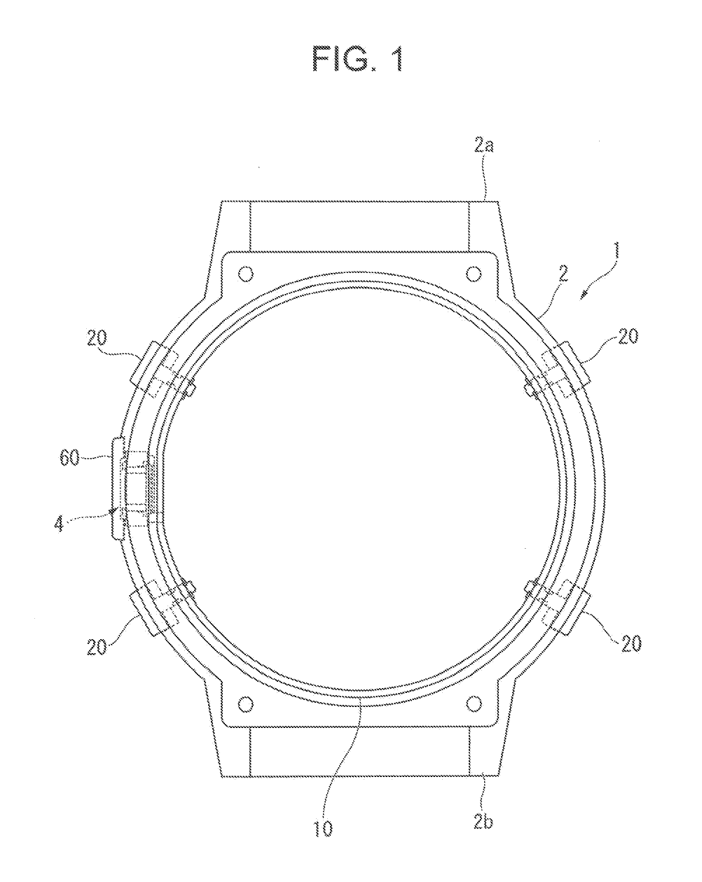

Next, a first embodiment of the invention will be explained with reference to FIG. 1 to FIG. 8.

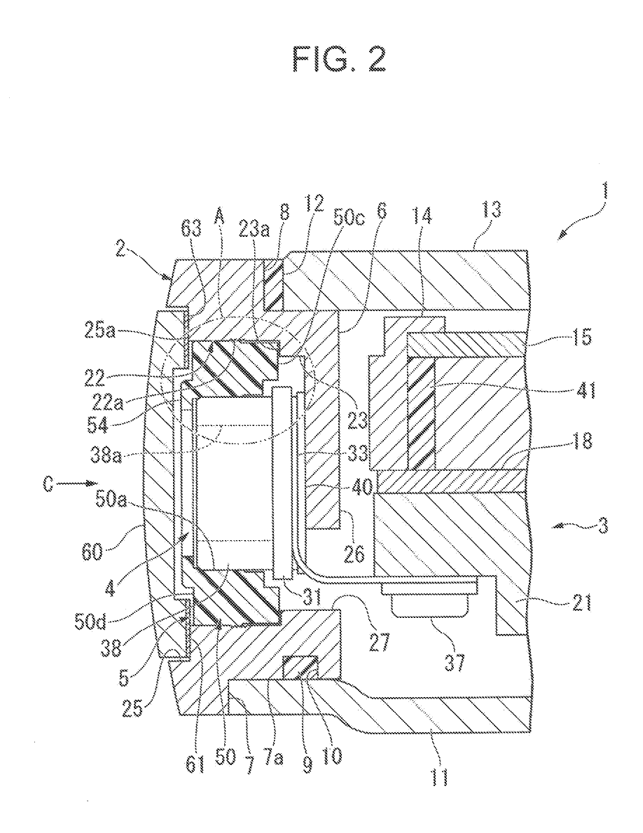

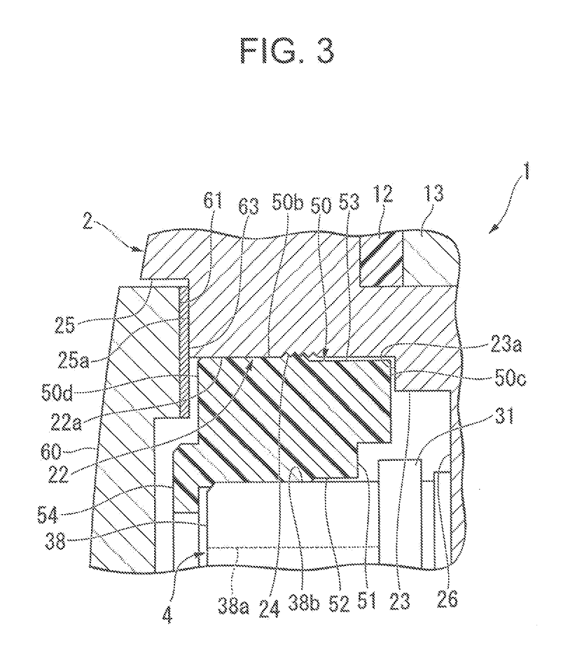

FIG. 1 is a plan view of an electronic watch with a pressure sensor 1 seen from a back surface side, showing a state in which a back cover 11 is removed. FIG. 2 is a vertical cross-sectional view of the electronic watch with the pressure sensor 1 and FIG. 3 is an enlarged view of a portion “A” in FIG. 2. In the electronic watch with the pressure sensor 1, a surface touching a user's arm when worn by the user is expressed as a back surface side and an surface on the opposite side of the back surface side as well as facing an outer direction is expressed as an outer surface side.

As shown in FIG. 1 to FIG. 3, the electronic watch with the pressure sensor 1 includes an external case 2, a watch movement 3 provided inside the external case 2 and a sensor unit 4. The sensor unit 4 is supported by the external case 2 through a case holding gasket 5.

Band attachment portions 2a and 2b to which a watch band (not shown) is attached are formed on the six o'clock side and the twelve o'clock side on side surfaces of the external case 2. Also on side surfaces of the external case 2, plural (four in the embodiment) changeover switches 20 are attached. The changeover switches 20 are for switching the content to be displayed on a later-described liquid crystal panel 15.

An opening 6 having an approximately circular shape in plan view is formed so as so occupy a major portion on the center of the external case 2, and concave portions 7 and 8 diameters of which are enlarged by steps to be larger than the opening 6 are respectively formed on the back surface side (a near side on the paper in FIG. 1 and a bottom side in FIG. 2) and on the outer surface side (far side on the paper in FIG. 1 and an upper side on the paper of FIG. 2). In the concave portion 7 on the back surface side, a gasket groove 10 for fitting a ring-shaped gasket 9 to a step surface 7a is formed. In the concave portion 7, the back cover 11 made of metal is provided so as to block the opening 6 over the gasket 9 fitted to the gasket groove 10.

On the other hand, a face glass 13 is provided in the concave portion 8 formed on the outer surface side of the external case 2 through a gasket 12 mounted on an inner peripheral surface so as to block the opening 6. The watch movement 3 is arranged in an inner space of the opening 6 blocked by the back cover 11 and the face glass 13.

The watch movement 3 has a panel frame 14 formed to have an approximately ring shape, and the panel frame 14 is attached to the opening 6 of the external case 2. Additionally, the liquid crystal panel 15 is held on the outer surface side of the panel frame 14. That is, the liquid crystal panel 15 is attached to the external case 2 through the panel frame 14.

The liquid crystal panel 15 is configured so that liquid crystal is sealed between a pair or glass substrate (not shown) to display time, detection results by the sensor unit 4 and so on. On the back surface side of the liquid crystal panel 15, a not-shown EL (Electroluminescence) panel illuminating the liquid crystal panel 15 from the back surface side is provided.

A main circuit substrate 18 is provided on the back surface side of the panel frame 14. The main circuit substrate 18 is formed to be an approximately circular shape in plan view so as to correspond to the shape of the opening 6, in which a given wiring pattern is formed on the surface thereof. Electronic components are mounted on given positions of the wiring pattern. As the electronic components, an IC chip, a capacitor and so on controlling oscillation of the contents and time to be displayed on the liquid crystal panel 15 can be cited.

A conductive rubber 41 is provided on the outer surface side of the main circuit substrate 18 as well as in a position corresponding to an outer peripheral portion of the liquid crystal panel 15 so as to extend between the main circuit substrate 18 and the liquid crystal panel 15. The main circuit substrate 18 and the liquid crystal panel 15 are electrically connected through the conductive rubber 41. A battery frame 21 is further fixed on the back surface side of the main circuit substrate 18 and a not-shown battery is held in the battery frame 21.

Here, on the side surface of the external case 2, a sensor housing opening 22 is formed on the three o'clock side (the left side in FIG. 1 and FIG. 2). A case holding gasket 5 is fitted into the sensor housing opening 22, and further, the sensor unit 4 is arranged on the center of the case holding gasket 5.

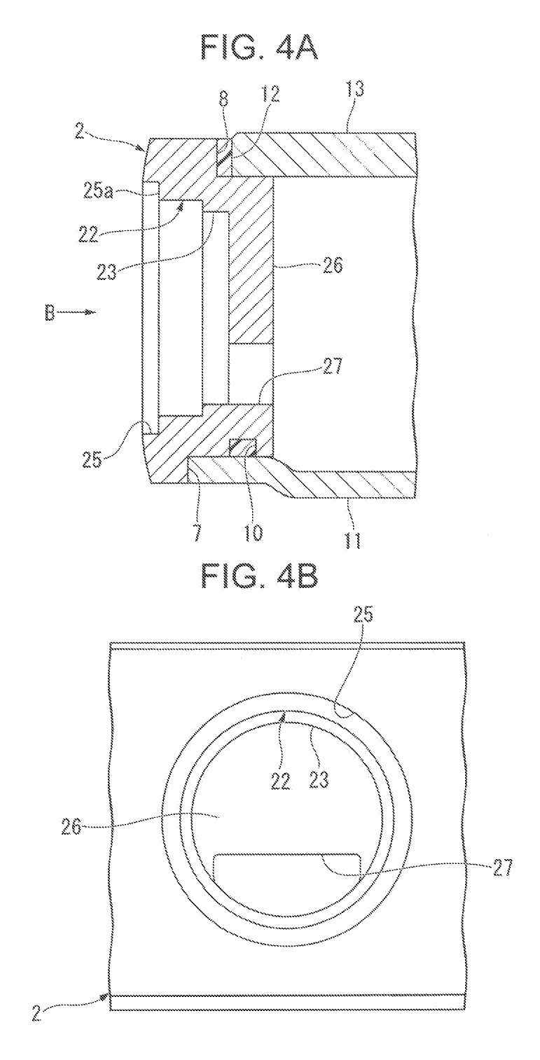

FIGS. 4A and 4B show the details of the sensor housing opening 22, in which FIG. 4A is a cross-sectional view in the vicinity of the sensor housing opening 22 in the external case 2 and FIG. 4B is a view seen from an arrow B in FIG. 4A.

As shown in FIG. 2 to FIGS. 4A, 48, the sensor housing opening 22 is formed to have an approximately circular shape in plan view in an axial direction. In the sensor housing opening 22, a reduced diameter portion 23 a diameter of which is reduced by a step is formed inside (the right side in FIG. 2 to FIGS. 4A, 4B; which is near the watch movement 3. The reduced diameter portion 23 is provided for performing positioning of the case holding gasket 5.

Furthermore, a rough surface portion 24 is formed at an approximate center in the axial direction on an inner peripheral surface 22a of the sensor housing opening 22. The rough surface portion 24 functions as a non-slip portion for the case holding gasket 5, which is formed by using a knurling process with respect to the inner peripheral surface 22a of the sensor housing opening 22.

Additionally, a concave portion 25 having an approximately circular shape in plan view a diameter of which is enlarged by a step to be larger than the sensor housing opening 22 is formed outside (the left side in FIG. 2 to FIGS. 4A and 4B) the sensor housing opening 22 in the axial direction. A sensor cover 60 is provided in the concave portion 25 so as to block the sensor housing opening 22.

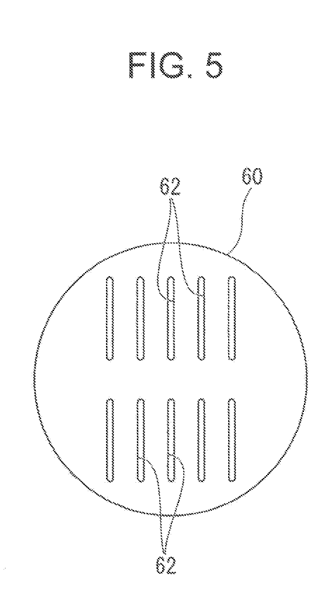

FIG. 5 is a plan view of the sensor cover 60.

As shown in FIG. 2, FIG. 3 and FIG. 5, the sensor cover 60 is formed to be an approximately disk shape so as to correspond to the concave portion 25 of the external case 2. Plural slips 62 are formed in a major portion of the sensor cover 60. External pressure is transmitted to the inside of the sensor cover 60 through these slits 62.

Additionally, a convex portion 61 having an approximately ring shape in plan view is formed at an outer peripheral portion of the inside surface of the sensor cover 60. An adhesive tape 63 is attached to an end surface of the convex portion 61, and the convex portion 61 is adhered to a step surface 25a in the concave portion 25 through the adhesive tape 63. The sensor cover 60 is attached to the concave portion 25 in the above manner.

Returning to FIG. 2 to FIGS. 4A, 4B, a wall portion 26 blocking the sensor housing opening 22 is formed inside the sensor housing opening 22 in the axial direction. A communicating opening 27 communicating the sensor housing opening 22 to the opening 6 of the exterior case 2 in which the watch movement 3 is arranged is formed in the wall portion 26. The sensor unit 4 is placed in the wall portion 26.

### (Sensor Unit)

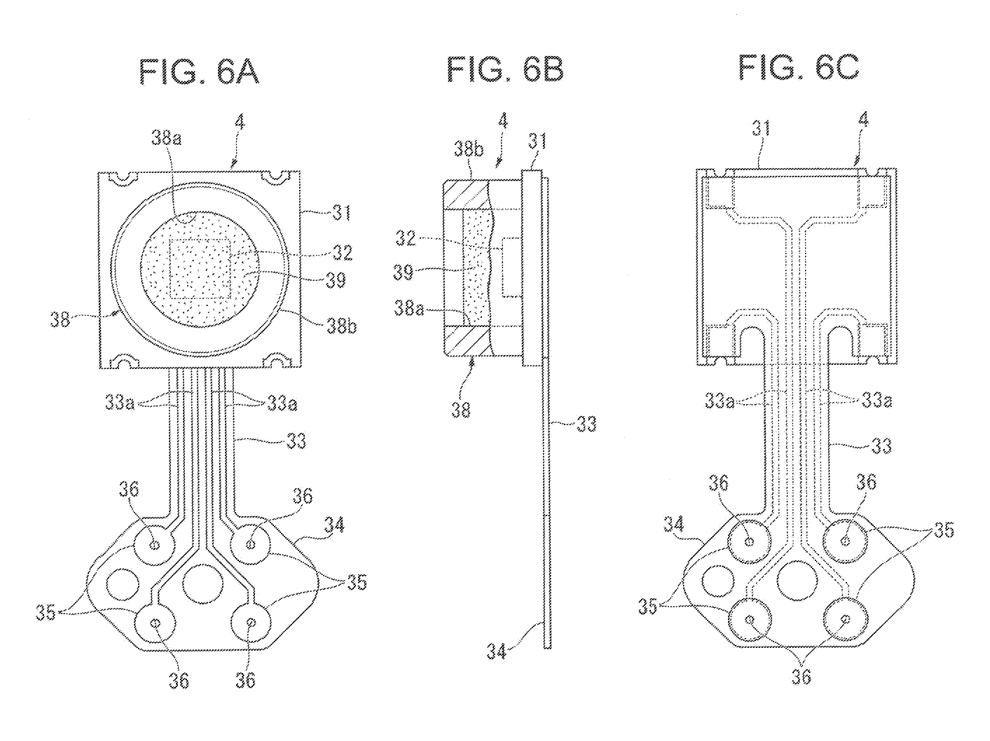

FIGS. 6A to 6C show the sensor unit 4, in which FIG. 6A is a plan view seen from one direction, FIG. 6B is a side view and FIG. 6C is a plan view seen from the other direction.

As shown in FIG. 2 and FIGS. 6A to 6C, the sensor unit 4 includes a sub-circuit substrate 31, The sub-circuit substrate 31 is formed to have an approximately square shape in plan view and a given wiring pattern (not shown) is formed on the surface thereof. A pressure sensor 32 is mounted on a given position of the wiring pattern.

The pressure sensor 32 is a semiconductor pressure sensor such as a bridge resistance measuring air pressure. The pressure sensor 32 can be configured as a pressure sensor measuring water pressure instead of air pressure.

One terminal of a flexible substrate 33 is connected to the sub-circuit substrate 31. A connection portion 34 for electrically connecting the flexible substrate 33 to the main circuit substrate 18 is integrally formed at the other terminal of the flexible substrate 33. In the connection portion 34, plural (four in the embodiment) land portions 35 formed at terminal portions of a wiring pattern 33a of the flexible substrate 33 are evenly arranged.

On centers of respective land portions 35, through holes 36 respectively piercing through the connection portion 34 are formed. Bolts 37 are inserted into the through holes 36. The bolts 37 are fastened and fixed to the battery frame 21 of the watch movement 3. Here, in the battery frame 21, conductive members (not shown) such as coil springs are inserted into portions where the bolts 37 are screwed so as to surround the bolts 37. Both ends of the conductive members are configured to touch the land portions 35 of the connection portion 34 and the given wiring pattern formed in the main circuit substrate 18, respectively. Accordingly, the sub-circuit substrate 31 and the main circuit substrate 18 are electrically connected.

Also, a protection case 38 formed to be a cylindrical shape so as to surround a periphery of the pressure sensor 32 is adhered to the sub-circuit substrate 31. The protection case 38 is provided for protecting the pressure sensor 32 from the outside, which is made of a metal such as stainless steel. The protection case 33 is adhered to the sub-circuit substrate 31 in a state in which hermeticity is secured, and a gel-type filling member is filled inside the protection case 38.

The sensor unit 4 having the above structure is set inside the sensor housing opening 22 of the external case 2 so that an opening 38a of the protection case 38 faces the sensor cover 60, and one terminal of the flexible substrate 33 connected to the sub-circuit substrate 31 of the sensor unit 4 is attached to the wall portion 26 of the external case 2 through a filler sheet 40.

### (Case Holding Gasket)

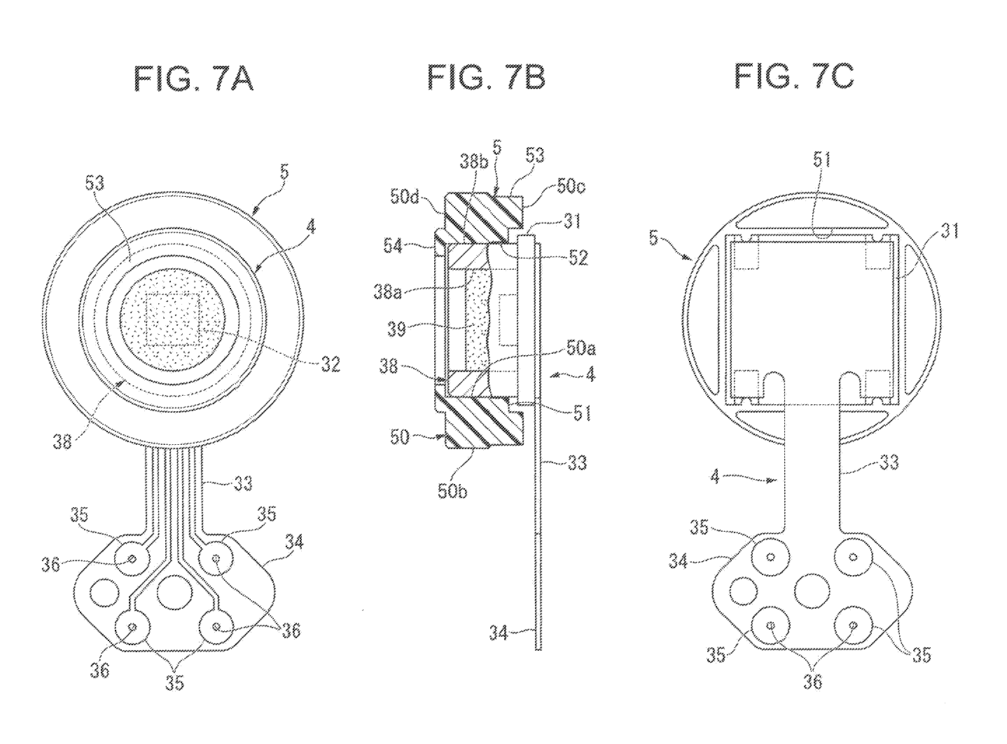

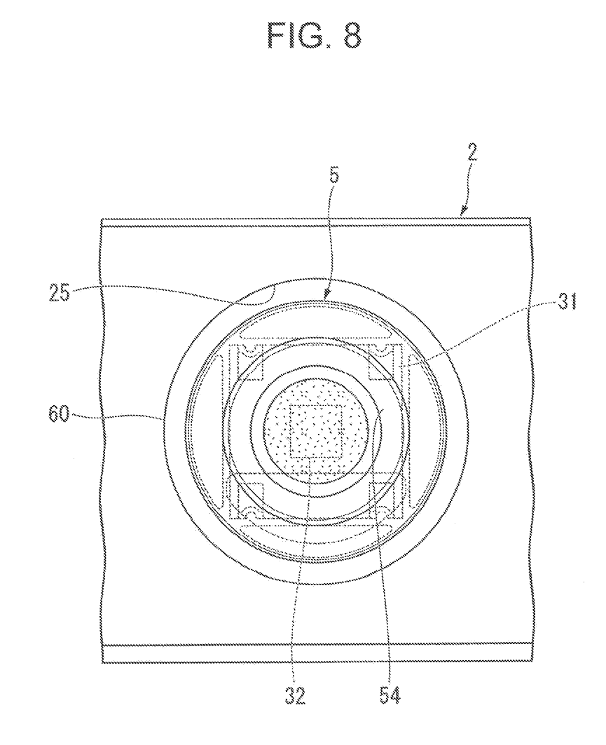

FIGS. 7A to 7C show a state in which the case holding gasket 5 is attached to the sensor unit 4, in which a FIG. 7A is a plan view seen from one direction, FIG. 7B is a side view and FIG. 7C is a plan view seen from the other direction. FIG. 8 is a perspective view seen from an arrow “C” in FIG. 2.

As shown in FIG. 2, FIG. 3, FIGS. 7A to 7C and FIG. 8, the case holding gasket 5 is made of resin, having a cylindrical portion 50 which can be fitted into the sensor housing opening 22 formed in the external case 2. An inner peripheral surface 50a of the cylindrical portion 50 is formed so that the protection case 38 can be fitted thereinto, a diameter of which is set to be slightly smaller than a diameter of an outer peripheral surface 38b the protection case 38.

A diameter of an outer peripheral surface 50b of the cylindrical portion 50 is set so as to be larger than an outer shape of the sub-circuit substrate 31 forming the sensor unit 4, namely, so as to be larger than a length of a diagonal line of the sub-circuit substrate 31. The diameter of the outer peripheral surface 50b of the cylindrical portion 50 is set so as to be slightly larger than an inside diameter of the sensor housing opening 22.

That is, the case holding gasket 5 is fitted between the inner peripheral surface 22a of the sensor housing opening 22 and the outer peripheral surface 38b of the protection case 38 through a given interference with respect to the sensor housing opening 22 and the protection case 38. Then, an end surface 50c near the sub-circuit substrate 31 of the cylindrical portion 50 abuts on a step surface 23a of the reduced diameter portion 23 formed in the sensor housing opening 22, thereby performing positioning of the case housing gasket 5.

In the inner peripheral surface 50a of the cylindrical portion 50, a clearance concave portion 51 is formed at an end portion near of the sub-circuit substrate 31 for avoiding interference with respect to the sub-circuit substrate 31. Also in the inner peripheral surface 50a of the cylindrical portion 50, a protection-case easily receiving unit 52 a diameter of which is slightly increased is formed between a position closer to the sub-circuit substrate 31 than the approximate center in the axial direction and the clearance concave portion 51.

In the outer peripheral surface 50b of the cylindrical portion 50, an external-case easily receiving unit 53 a diameter of which is slightly reduced is formed between the approximate center in the axial direction and the end surface 50c near the sub-circuit substrate 31.

On as end surface 50d of the cylindrical portion 50 on the opposite side of the sub-circuit substrate 31, an inward flange portion 54 is formed. The inward flange portion 54 has a function of preventing the sensor unit 4 from falling off the external case 2 (which will be described later).

### (Attachment of Sensor Unit)

Next, procedures of attaching the sensor unit 4 to the external case 2 and operation of the case holding gasket 5 will be explained with reference to FIG. 2, FIG. 3, FIGS. 6A to 6C and FIGS. 7A to 7C.

As shown in FIG. 2, FIG. 3, FIGS. 6A to 6C and FIGS. 7A to 7C, a tip portion of the protection case 38 of the sensor unit 4 is turned to the end surface 50c where the clearance concave portion 51 of the case holding gasket 5 is formed for attaching the sensor unit 4 to the external case 2. Then, the tip portion is inserted to the inner peripheral surface 50a of the cylindrical portion 50 of the case holding gasket 5 to thereby fit the protection case 38 to the cylindrical portion 50.

In this case, a diameter of the inner peripheral surface 50a of the cylindrical portion 50 is set to be slightly smaller than the diameter of the outer peripheral surface 38b of the protection case 38, and the protection case 38 is fitted to the cylindrical portion 50 through the interference. Here, the protection-case easily receiving unit 52 the diameter of which is slightly increased is formed in the inner peripheral surface 50a of the case holding basket 5, therefore, the protection case 38 is inserted deeply into the case holding gasket 5 through the protection-case easily receiving unit 52. Accordingly, as there is a backlash between the case holding gasket 5 and protection case 38 at the tip portion of the protection case 38 to be inserted into the case holding gasket 5, the protection case 38 can be inserted into the case holding gasket 5 smoothly.

When the protection case 38 is inserted into the cylindrical portion 50, not only the case holding gasket 5 and the protection case 38 are united but also the sub-circuit substrate 31 on which the pressure sensor 32 is mounted is also united. That is, the protection case 38 also has a function of supporting the pressure sensor 32 through the sub-circuit substrate 31 in addition to the function of protecting the pressure sensor 32 from the outside.

Subsequently, the case holding gasket 5 and the sensor unit 4 united as described above are assembled to the external case 2. Specifically, the sub-circuit substrate 31 included in the sensor unit 4 is turned to the direction of the sensor housing opening 22 of the external case 2. Then, the case holding gasket 5 is inserted into the sensor housing opening 22 in that state from the outside of the external case 1, to thereby fit the case holding gasket 5 to the sensor housing opening 22.

In this process, the connection portion 34 of the flexible substrate 33 is inserted to the communicating opening 27 formed in the wall portion 26 of the external case 2 to thereby fix the connection portion 34 to the battery frame 21. Then, the flexible substrate 33 is electrically connected to the main circuit substrate 18 through a not-shown conductive member.

The diameter of the outer peripheral surface 50b of the cylindrical portion 50 is set so as to be slightly larger than the inside diameter of the sensor housing opening 22, and the cylindrical portion 50 of the case holding gasket 5 is fitted to the sensor housing opening 22 through an interference.

The cylindrical portion 50 of the case holding gasket 5 is slightly compressed and deformed by the inner peripheral surface 22a of the sensor housing opening 22 and the outer peripheral surface 38b the protection case 38. Accordingly, inner peripheral surface 22a of the sensor housing opening 22 closely touches the outer peripheral surface 50b of the cylindrical portion 50 of the case holding gasket 5 as well as the inner peripheral surface 50a of the cylindrical portion 50 of the case holding gasket 5 closely touches the outer peripheral surface 38b the protection case 38. Therefore, the sensor housing opening 22 and the protection case 38 are completely sealed, thereby preventing water or dust from entering the inside from the gap therebetween.

As the cylindrical portion 50 of the case holding gasket 5 is slightly compressed and deformed by the inner peripheral surface 22a of the sensor housing opening 22 and the outer peripheral surface 38b or the protection case 38, lateral pressure is applied to the inner peripheral surface 22a of the sensor housing opening 22 and the outer peripheral surface 38b the protection case 38 due to the cylindrical portion 50. Due to the lateral pressure, sliding resistance between the inner peripheral surface 22a of the sensor housing opening 22 and the outer peripheral surface 50b of the cylindrical portion 50 is increased as well as sliding resistance between the inner peripheral surface 50a of the cylindrical portion 50 of the case holding basket 5 and the outer peripheral surface 38b of the protection case 38 is increased. Accordingly, the case holding gasket 5 and the sensor unit 4 are fixed inside the sensor housing opening 22.

Here, in the cylindrical portion 50 of the case holding gasket 5, the external-case easily receiving unit 53 the diameter of which is slightly reduced is formed at the outer peripheral surface 50b, and the cylindrical portion 50 of the case holding gasket 5 is inserted deeply into the sensor housing opening 22 through the external-case easily receiving unit 53. Accordingly, as there is a backlash between the sensor housing opening 22 and the cylindrical portion 50 at a tip portion of the cylindrical portion 50 to he inserted into the sensor hooting opening 22, the cylindrical portion 50 can he inserted into the sensor housing opening 22 smoothly.

Additionally, when the cylindrical portion 50 is pushed until the end surface 50c of the cylindrical portion 50 near the sub-circuit substrate 31 abuts on the step surface 23a of the reduced diameter portion 23 in the sensor housing opening 22, the outer peripheral surface 50b of the cylindrical portion 50 abuts on the a rough surface portion 24 formed on the inner peripheral surface 22a of the sensor housing opening 22. As the rough surface portion 24 is formed by using the knurling process, sliding resistance of the outer peripheral surface 50b of the cylindrical portion 50 in the rough surface portion 24 is increased. Accordingly, the case holding gasket 5 hardly falls off the sensor housing opening 22.

Furthermore, the inward flange portion 54 is formed on the end surface 50d of the cylindrical portion 50 on the opposite side of the sub-circuit substrate 31. Here, the protection case 38 of the sensor unit 4 is inserted from the opposite side of the inward flange portion 54 of the cylindrical portion 50 and fitted to the cylindrical portion 50. Accordingly, the inward flange portion 54 functions as a wall for regulating a fall-off direction of the protection case 38 to the outside of the external case 2. Accordingly, it is possible to prevent the sensor unit 4 from falling off to the outside of the external case 2 even when inner pressure becomes higher than external pressure of the external case 2.

After fixing the case holding gasket 5 and the sensor unit 4 inside the sensor housing opening 22, the sensor cover 60 is attached to the concave portion 25 of the external case 2 from the outside. In this process, the adhesive tape 63 is adhered to the convex portion 61 of the sensor cover 60, and the adhesive tape 63 is adhered to the step surface 25a of the concave portion 25. Accordingly, the attachment of the sensor unit 4 to the external case 2 is completed.

When the atmosphere or water is introduced into the sensor housing opening 22 through the slits 62 of the sensor cover 60 under the above configuration, a filling member 39 filled in the protection case 38 of the sensor unit 4 is pressed and a pressing force is detected by the pressure sensor 32. Here, as the protection case 38 is adhered in a state in which hermeticity is secured with respect to the sub-circuit substrate 31, the filling member 39 does not escape. Even when pressure from the outside is received, the pressure is not transmitted to the inside filling member 39 from between the sub-circuit substrate 31 and the protection case 38. Accordingly, the pressure sensor 32 can accurately detect the pressure transmitted through the slits 62 of the sensor cover 60.

The detection result by the pressure sensor 32 is outputted to the main circuit substrate 18 as a signal through the sub-circuit substrate 31 and the flexible substrate 33. Then, the signal is inputted to an IC chip and so on mounted on the main circuit substrate 18 and a calculated content is displayed on the liquid crystal panel it based on a calculation result of the IC chip and so on.

According to the first embodiment, the sensor unit 4 is set to the sensor housing opening 22 through the case holding basket 5 and the sensor unit 4 can be positively fixed in the sensor housing opening 22 by utilizing lateral pressure generated by the case holding gasket 5. Accordingly, it is not necessary to hold the sensor unit 4 from the outside by using another member as in related art, and the sensor cover 60 can be fixed to the external case 2 by the adhesive tape 63. Therefore, screws and so on for fixing the sensor cover 60 used in related art are not necessary either, which can reduce the number of components as well as reduce the size of the external case 2. As a result, the entire electronic watch with the pressure sensor 1 can he made small in size.

Additionally, in the cylindrical portion 50 of the case holding gasket 5, the inward flange portion 54 is formed on the end surface 50d on the opposite side of the sub-circuit substrate 31, therefore, it is possible to reliably prevent the sensor unit 4 from falling off the case holding gasket 5 to the outside of the external case 2 with a simple structure inexpensively.

Furthermore, the rough surface portion 24 is formed at the approximate center in the axial direction on the inner peripheral surface 22a of the sensor housing opening 22, and the outer peripheral surface 50b of the cylindrical portion 50 abuts on the rough surface portion 24 when the case holding gasket 5 is inserted, therefore, the sliding resistance of the outer peripheral surface 50b of the cylindrical portion 50 in the rough surface portion 24 is increased, so that the case holding gasket 5 does not easily fall off the sensor housing opening 22. Accordingly, reliability of the electronic watch with the pressure sensor 1 as a product can be improved with the simple structure inexpensively.

### Second Embodiment

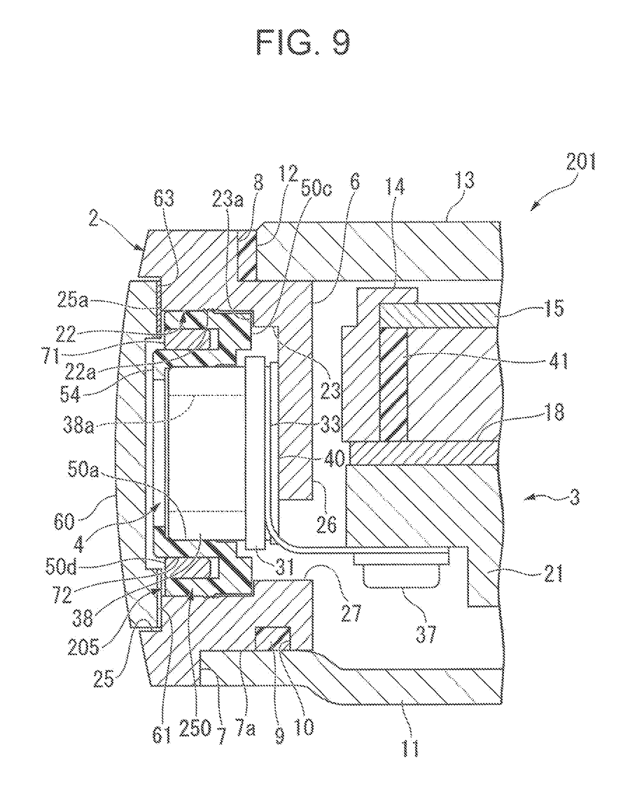

Next, a second embodiment of the present invention will be explained with reference to FIG. 9. The same components as five first embodiment will be explained by giving the same reference numerals (the same applies to other embodiments).

FIG. 9 is a vertical cross-sectional view of an electronic watch with a pressure sensor 201 according to the second embodiment, which corresponds to FIG. 2 of the above first embodiment.

In the second embodiment, the electronic watch with the pressure sensor 1 includes the external case 2, the watch movement 3 provided inside the external case 2 and the sensor unit 4. The basic structure is the same as the first embodiment explained above (the same applied to other embodiments), for example, in a point that the sensor unit 4 is supported in the external case 2 through a case holding gasket 205, a point that the sensor housing opening 22 is formed on the side surface of the external case 2, the case holding gasket 205 is fitted into the sensor housing opening 22 and the sensor unit 4 is arranged at the center of the case housing gasket 205, in a point that lateral pressure is applied to the inner peripheral surface 22a of the sensor housing opening 22 and the outer peripheral surface 38b the protection case 38 due to the case holding gasket 205 to regulate the falling of the case holding gasket 205 and the sensor unit 4, and in a point that the sensor cover 60 is attached to the sensor housing opening 22 from the outside of the case holding gasket 205 and the sensor unit 4 by using the adhesive tape 63 and so on.

Here, the second embodiment differs from the first embodiment in a point that an insertion ring 71 for fixing the case holding gasket 205 is provided in the case holding gasket 205 in the second embodiment though the insertion ring 71 is not provided in the case holding gasket 5 of the first embodiment.

More specifically, as shown in FIG. 9, a groove portion 72 having an approximately ring shape in plan view in the axial direction is formed in the end surface 50d of a cylindrical portion 250 in the case holding gasket 205 on the opposite side of the sub-circuit substrate 31 so as to surround an outer periphery of the inward flange portion 54.

The insertion ring 71 is provided so as to be inserted to the groove portion 72. A thickness of the insertion ring 71 is set to be slightly larger than a groove width of the groove portion 72.

Under the above structure, the sensor unit 4 is attached to the case holding gasket 205. After the case holding gasket 205 and the sensor unit 4 are attached to the sensor housing opening 22 from the outside, the insertion ring 71 is inserted to the groove 72 of the case holding gasket 205.

Accordingly, the groove portion 72 is extended in a width direction and a pressing force with respect to the inner peripheral surface 22a of the sensor housing opening 22 by the case holding bashes 205 is increased as well as a pressing force with respect to the outer peripheral surface 38b of the protection case 38 by the case holding gasket 205 is increased.

According to the above second embodiment, not only the same advantages as the first embodiment can be obtained but also the pressing force with respect to the inner peripheral surface 22a of the sensor housing opening 22 as well as the pressing force with respect to the outer peripheral surface 38b of the protection case 38 by the case holding gasket 205 are increased to thereby increase sliding resistance, which can prevent the sensor unit 4 from falling off the external case 2 further reliably.

Additionally, the groove portion 72 is formed in the cylindrical portion 250 of the case holding gasket 205, thereby reducing the thickness of the cylindrical portion 250. That is, for example, when the thickness of the cylindrical portion 50 in the first embodiment is set to approximately 1.5 mm, the thickness of the cylindrical potion 250 in the second embodiment can be set to approximately 0.5 mm uniformly.

Accordingly, for example, when the case holding basket 205 is formed by metallic molding, it is possible to prevent occurrence of sink marks at the time of molding. As a result, size variation of the case holding gasket 205 after molding can be reduced as well as sealing property and assembly property due to the case holding gasket 205 can be improved.

In the above second embodiment, the case in which the groove portion 72 having the approximately ring shape in plan view in the axial direction is formed in the end surface 50a of the cylindrical portion 250 as well as the insertion ring 71 to be inserted to the groove portion 72 is provided has been explained. However, it is also preferable that the groove portion 72 is not formed over the entire circumference but a plural number of groove portions are formed along a circumferential direction and the insertion ring 71 is formed to be divided into plural portions so as to correspond to the groove portions which are intermittently formed.

### Third Embodiment

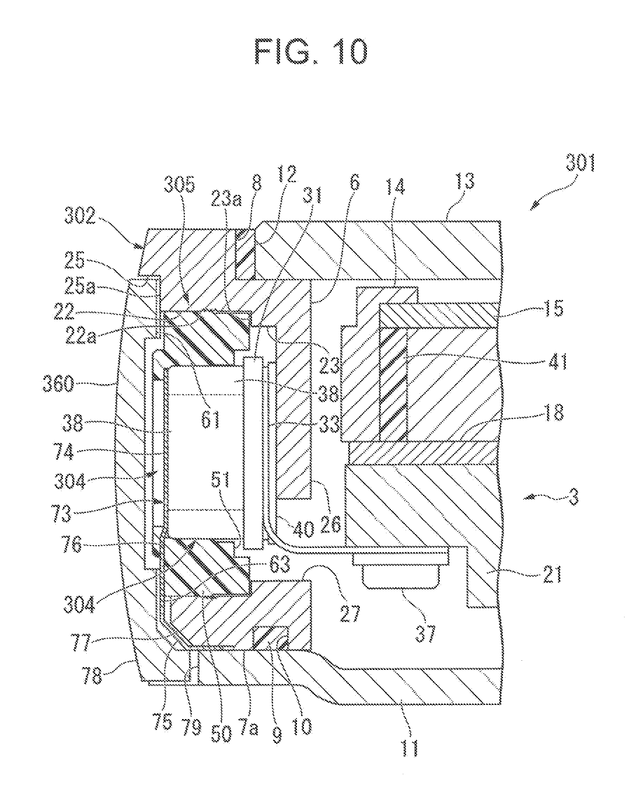

Next, a third embodiment of the present invention will be explained with reference to FIG. 10.

FIG. 10 is a vertical cross-sectional view of an electronic watch with a pressure sensor 301 according to the third embodiment, which corresponds to FIG. 2 of the above first embodiment.

Here, the third embodiment differs from the first embodiment in a point that a sensor unit 304 according to the third embodiment is provided with a conductive sheet 73 at an outside end in the axial direction of the protection case 38 though the sheet 73 is not provided in the sensor unit 4 of the first embodiment.

Here specifically, as shown in FIG. 10, the sheet 73 includes a sheet body 74 formed so as to cover the outside end in the axial direction of the protection case 38. A back-cover touch portion 75 is integrally formed at a periphery of the sheet body 74 near the back cover 11. The back-cover touch portion 75 extends from the sheet body 74 along the end surface 50d on the opposite side of the sub-circuit substrate 31 in the cylindrical portion 350 of the case holding gasket 305, then, bends so as to enter the inside of an external case 302 and touches the back cover 11 at a tip thereof.

In the inward flange portion 54 formed in the cylindrical portion 50 included in the case holding gasket 305, a cut-off portion 76 for avoiding interference with respect to the back-cover touch portion 75 is formed at a portion corresponding to the back-cover touch portion 75 in the sheet 73. Also at portions corresponding to the back-cover touch portion 75 in the external case 302, namely, at a portion of the sensor housing opening 22 formed in the external case 302 near the back cover 11 and a portion of the concave portion 25 near the back cover 11, a cut-off portion 77 is formed so that the sheet 73 can foe laid from the outside end in the axial direction of the protection case 38 to the back cover 11.

Furthermore, an extended portion 78 extended to the back cover 11 is integrally formed in the sensor cover 300 attached to the concave portion 25 of the external case 302 so as to block the sensor housing opening 22 and the cut-off portion 77. The adhesive tape 63 for attaching the sensor cover 360 to the concave portion 25 is adhered also to the extended portion 78.

A cut-out portion 79 which can receive the extended portion 78 is formed in the back cover 11 at a portion corresponding to the extended portion 78 of the sensor cover 360.

When the sensor unit 304 in which the sheet 73 is arranged is attached to the sensor housing opening 22 of the external case under the above structure, the cut-off portion 77 is formed at the portion corresponding to the back-cover touch portion 75 of the external case 302, therefore, the back-cover touch portion 75 or the sheet 73 can be drawn easily so that the tip touches the back cover 11.

After the back-cover touch portion 75 is drawn to the back cover 11, the sensor cover 360 is attached from the outside. At this time, as the extended potion 78 formed in the sensor cover 360 Is extended to reach the back cover 11, the back-cover touch portion 75 of the sheet 73 is pressed by the extended portion 78. The sheet 73 fixed as described above is grounded as the back cover 11 is made of metal.

According to the above third embodiment, not only the same advantages as the first embodiment can be obtained but also malfunction of the pressure sensor 32 due to electrostatic can be prevented by the sheet 73.

It is also possible to draw the back-cover touch portion 75 of the sheet 73 easily by forming the cut-off portion 77 in the external case 302, which can prevent deterioration in assembly property.

Furthermore, as the extended portion 78 is formed in the sensor cover 360, the sheet 73 is not exposed outside and there is no danger of spoiling the beauty.

Additionally, as the extended portion 78 of the sensor cover 360 presses the back-cover touch portion 75 of the sheet 73 from the outside, the sheet 73 can be positively fixed. Accordingly, the electronic watch with the pressure sensor 301 with high product reliability can be provided.

### Fourth Embodiment

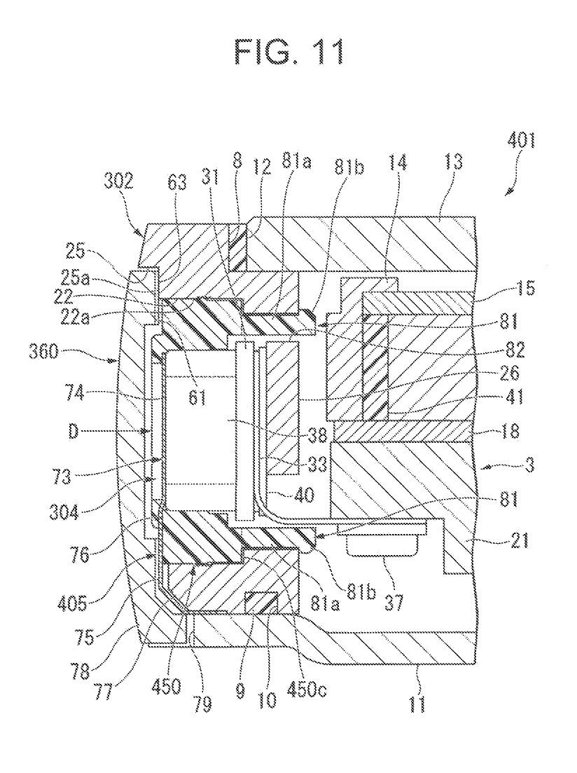

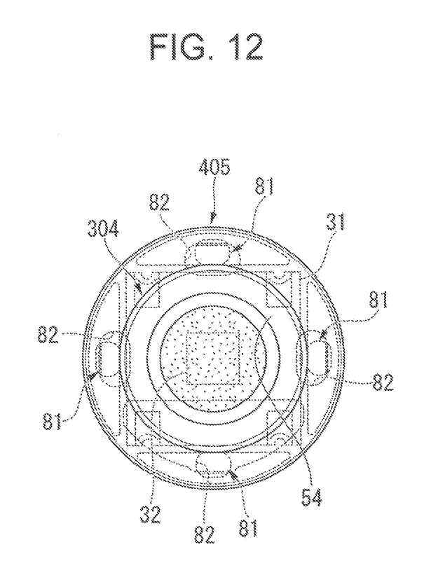

Next, a fourth embodiment of the present invention will be explained with reference to FIG. 11 and FIG. 12.

FIG. 11 is a vertical cross-sectional view of an electronic watch with a pressure sensor 401 according to the fourth embodiment, which corresponds to FIG. 10 of the above third embodiment. FIG. 12 is a perspective view seen from an arrow “D” of FIG. 11.

Here, the fourth embodiment differs from the third embodiment in a point that hook portions 81 which can be engaged with the sensor housing opening 22 are integrally formed in a case holding gasket 405 of the fourth embodiment though the hook portions 81 are not integrally formed in the case holding gasket 305 of the third embodiment.

More specifically, as shown in FIG. 11 and FIG. 12, plural hook portions 81 (four in the fourth embodiment) arranged at equal intervals in the circumferential direction are integrally formed in a cylindrical portion 450 of the case holding gasket 405 at an end surface 450c near the sub-circuit substrate 31. Each hook portion 81 includes an arm 81a extending from the end surface 450c of the cylindrical portion 450 toward the vicinity of the opening 6 where the watch movement 3 is housed and a hook 81b integrally formed at a tip of the arm 81a.

On the other hand, openings 82 to oh ion the hook portion 81 can be inserted are formed inside the sensor housing portion 22 in the axial direction on the wall portion 26 formed so as to block the sensor housing opening 22 at positions corresponding to the hook portions 81. The arms 81a or the hook portions 81 extend inside the sensor housing opening 22 in the axial direction through the openings 82 and the hooks 81b are engaged with a peripheral edge of the sensor housing opening 22.

According to the above fourth embodiment, not only the same advantages as the third embodiment can be obtained, but also it is possible to prevent the case holding gasket 405 from falling off the external case 302 more reliably, as a result, it is possible to prevent the sensor unit 304 from falling off the external case 302 more reliably.

In the above fourth embodiment, the case in which four hook portions 81 are integrally formed in the cylindrical portion 450 of the case holding gasket 405 has been explained. However, the invention is not limited to the example and it is sufficient that at least two hook portions 81 are formed. It is possible to prevent the case holding gasket 405 from falling off the external case 302 more reliably by applying the above structure.

It is also possible to apply the hook portions 81 of the tot roe embodiment to the case holding gasket 5 of the first embodiment or the case holding gasket 205 of the second embodiment.

Moreover, the present invention is not limited to the above embodiments and includes various modifications of the above embodiments within a scope not departing from the gist of the present invention.

For example, in the above embodiments, the cases in which the adhesive tape 63 is adhered to the sensor covers 60 and 360 when the sensor covers 60 and 360 are attached to the concave portions 25 formed in the external cases 2 and 302 have been explained. However, the invention is not limited to these examples, and it is sufficient that the sensor covers 60 and 360 can be fixed to the concave portion 25 without using a fixing member such as a screw. It is also preferable to use adhesive and so on instead of using the adhesive tape 63.

What is claimed is:

1. An electronic timepiece comprising:
an external case;
a pressure sensor provided in tine external case and detecting pressure; and
a protection case formed so as to surround an outer peripheral surface of the pressure sensor, which can protect and support the pressure sensor,
wherein a sensor housing opening which can house the pressure sensor and the protection case is formed in the external case, and the protection case is arranged near a center portion of the sensor housing opening,
a case holding gasket having a cylindrical portion fitted between an inside surface of the sensor housing opening and an outside surface of the protection case through a given interference with respect to the sensor housing opening and the protection case, and
a fall-off regulating portion for the protection case regulating movement in a direction in which the protection case falls off the external case toward the outside is provided in the case holding gasket.

2. The electronic timepiece according to claim 1,
wherein the fall-off regulating portion for the protection case is an inward flange portion formed in the cylindrical portion.

3. The electronic timepiece according to claim 1,
wherein a fall-off regulation portion for the gasket regulating movement in a direction in which the case holding basket fails off the external case toward the outside is provided inside the external case in a thickness direction on an inside surface of the sensor housing opening.

4. The electronic timepiece according so claim 2,
wherein a fall-off regulation portion for the gasket regulating movement in a direction in which the case holding basket falls off the external case toward the outside is provided inside the external case in a thickness direction on an inside surface of the sensor housing opening.

5. The electronic timepiece according to claim 3,
wherein a rough surface portion which is rougher in surface roughness than other portions is formed on the inside surface of the sensor housing opening and the rough surface portion is formed as the fall-off regulation portion for the gasket.

6. The electronic timepiece according to claim 4,
wherein a rough surface portion which is rougher in surface roughness than other portions is formed on the inside surface of the sensor housing opening and the rough surface portion is formed as the fall-off regulation portion for the gasket.

7. The electronic timepiece according to claim 1,
wherein a groove portion is formed on an outside end surface in the axial direction of the cylindrical portion as well as an insertion device formed so as to be inserted to the groove portion and extending the groove portion in a thickness direction of the cylindrical portion.

8. The electronic timepiece according to claim 2,
wherein a groove portion is formed on an outside end surface in the axial direction of the cylindrical portion as well as an insertion device formed so as to be inserted to the groove portion and extending the groove portion in a thickness direction of the cylindrical portion.

9. The electronic timepiece according to claim 3,
wherein a groove portion is formed on an outside end surface in the axial direction of the cylindrical portion as well as an insertion device formed so as to be inserted to the groove portion and extending the groove portion in a thickness direction of the cylindrical portion.

10. The electronic timepiece according to claim 4,
wherein a groove portion is formed on an outside end surface in the axial direction of the cylindrical portion as well as an insertion device formed so as to be inserted to the groove portion and extending the groove portion in a thickness direction of the cylindrical portion.

11. The electronic timepiece according to claim 5,
wherein a groove portion is formed on an outside end surface in the axial direction of the cylindrical portion as well as an insertion device forced so as to be inserted to the groove portion and extending the groove portion in a thickness direction of the cylindrical portion.

12. The electronic timepiece according to claim 6,
wherein a groove portion is formed on an outside end surface in the axial direction of the cylindrical portion as well as an insertion device formed so as to foe inserted to the groove portion and extending the groove portion in a thickness direction of the cylindrical portion.

13. The electronic timepiece according to claim 1,
wherein a hook portion which can be engaged with the sensor housing opening is provided in the cylindrical portion.

14. The electronic timepiece according to claim 2,
wherein a hook portion which can be engaged with the sensor housing opening is provided in the cylindrical portion.

15. The electronic timepiece according to claim 3,
wherein a hook portion which can be engaged with the sensor housing opening is provided in the cylindrical portion.

16. The electronic timepiece according to claim 4,
wherein a hook portion which can foe engaged with the sensor housing opening is provided in the cylindrical portion.

17. The electronic timepiece according to claim 5,
wherein a hook portion which can be engaged with the sensor housing opening is provided in the cylindrical portion.

18. The electronic timepiece according to claim 6,
wherein a hook portion which can be engaged with the sensor housing opening is provided in the cylindrical portion.

19. The electronic timepiece according to claim 1,
wherein a conductive sheet is arranged at an outside end in the axial direction of the protection case and a back-cover touch portion which can touch a back cover provided in the external case is provided in the sheet.

20. The electronic timepiece according to claim 2,
wherein a conductive sheet is arranged at an outside end in the axial direction of the protection case and a back-cover touch portion which can touch a back cover provided in the external case is provided in the sheet.
